(19) United States
(12) Patent Application Publication
(10) Pub. No.: US 2025/0050979 A1
(43) Pub. Date: Feb. 13, 2025

(54) HELICAL ANCHOR GROUP INSTALLATION SYSTEM

(71) Applicant: Triton Systems, Inc., Chelmsford, MA (US)

(72) Inventors: Zachary MILLER, Merrimack, NH (US); Rafael MANDUJANO, Arlington, MA (US); Aaron BRADSHAW, East Greenwich, RI (US); Tyler ROBERTSON, Chelmsford, MA (US); Tyson LAWRENCE, Chelmsford, MA (US)

(73) Assignee: Triton Systems, Inc., Chelmsford, MA (US)

(21) Appl. No.: 18/921,503

(22) Filed: Oct. 21, 2024

Related U.S. Application Data
(63) Continuation of application No. 17/101,978, filed on Nov. 23, 2020.
(60) Provisional application No. 62/939,239, filed on Nov. 22, 2019.

(51) Int. Cl. B63B 21/50; B63B 35/44; F03D 13/25

(52) U.S. Cl. CPC B63B 21/50; B63B 35/44; F03D 13/25; B63B 2035/446

(57) ABSTRACT

Disclosed herein is an offshore anchor system comprising two or more helical anchors, each having a predetermined length; and a template acting as a base connecting the two or more helical anchors. Some embodiments further comprise a skirt protruding from the periphery of the template in a direction substantially parallel to the length of the two or more helical anchors thereby providing additional lateral support.

### CROSS-REFERENCE TO RELATED APPLICATIONS

This application is a continuation of Non-provisional application Ser. No. 17/101,978 filed on Nov. 23, 2020, and entitled “HELICAL ANCHOR GROUP INSTALLATION SYSTEM,” which claims the benefit of priority of U.S. Provisional Patent Application Ser. No. 62/939,239, filed on Nov. 22, 2019, and entitled “HELICAL ANCHOR GROUP INSTALLATION SYSTEM,” both of which are incorporated by reference herein in their entirety.

### GOVERNMENTAL RIGHTS

This invention was made with government support under contract number DE-SC001 7969, project number 2576, awarded by the Department of Energy. The government has certain rights in the invention.

### SUMMARY OF THE DISCLOSURE

Disclosed herein is an offshore anchor system comprising two or more helical anchors, each having a predetermined length; and a template acting as a base connecting the two or more helical anchors. Some embodiments further comprising a skirt protruding from the periphery of the template in a direction substantially parallel to the length of the two or more helical anchors thereby providing additional lateral support. In some embodiments, the skirt protrudes from the template in the same direction as the two or more helical anchors, wherein the skirt protrudes about 5% to about 50% of the length of the two or more helical anchors on site. In some embodiments, the template and the skirt are separate items that can be assembled. In some embodiments, the offshore anchor system comprising two or more helical anchors, each having a predetermined length; a template acting as a base connecting the two or more helical anchors, and a skirt protruding from the periphery of the template in a direction substantially parallel to the length of the two or more helical anchors and for a distance of about 5% to about 50% of the length of the helical anchor thereby providing additional lateral support. Some embodiments provide a method of anchoring an offshore floating platform comprising anchoring such anchor systems to the seafloor and mooring a floating platform thereto. These and other aspects will be apparent from this disclosure.

### BRIEF DESCRIPTION OF THE DRAWINGS

FIG. 1 is a schematic depiction of a wind turbine and anchoring system in accordance with an embodiment described herein.

FIG. 2 is a partial cut-away view of an anchoring system as described herein.

The drawings are illustrative only and are not necessarily to scale.

### DETAILED DESCRIPTION

The popularity of offshore wind farms is increasing, as is its practicality. Key to the success of such offshore wind farms is safely anchoring the turbines. The current anchoring solutions are massive in size for the growing increase in turbines which creates installation issues, transportation complications, and extensive manufacturing. The invention provides a solution that is easily manufactured, shippable and provides a straightforward installation in a lower overall cost to the offshore floating wind farms. The proposed anchoring solutions benefit from one or more of low cost, ease of manufacture, low noise, ease of shipping, simpler installation, etc.

Instead of massive anchoring solutions, the proposed system employs multiple small easily manufactured helical anchors in close proximity combined with template and an optional skirt. Such a combination is not used in the offshore floating wind sector.

The systems disclosed herein use multiple small helical anchors, a template, and an optional skirt to provide the uplift and lateral capacities required to moor a floating wind platform. The invention is made up of three components to provide the capacities needed for the offshore wind sector; helical anchors, a template, and an optional skirt. The anchor system will be installed by a subsea remote tool. The helical anchors provide the majority of the uplift capacity for the system.

Helical anchors are installed by applying torque and crowd (down force) and screwing them into the seabed. Based on the site-specific soil conditions, the helical anchors style, size and length will be determined for the optimal performance. The template is a base platform that holds all the helical anchors together and provides a mooring connection for the floating platform or to which the rigid components are connected. The template also provides the base for the subsea tool to sit on while each anchor is installed. The template will provide some uplift and lateral capacities but compared to the overall system will have relatively small benefits. The main purpose of the template is to provide stability and load transfer from anchor to anchor from the mooring connection point. The skirt will provide increased lateral capacity for the system.

Each helical anchor comprises of a shaft, and a helical plate. Shaft lengths may range from approximately 5-20 feet and may be connected by couplers. The helical plate is designed and positioned such that twisting the anchor forces the shaft downward into the seabed. Multiple anchors maybe employed in a single anchor system held together via the template.

The template comprises a base portion that may be made of any suitable material, such as, but not limited to concrete and/or metal. The template engages and connects each of the multiple anchors together as a system. The template and anchors may be transported separately and assembled in place, making the system easy to transport, use, and install, as well as making it scalable depending on site needs.

The skirt comprises an exterior shell ranging in size and thickness attached to the circumference of the template, made of suitable material which includes but is not limited to metal, stone, or concrete.

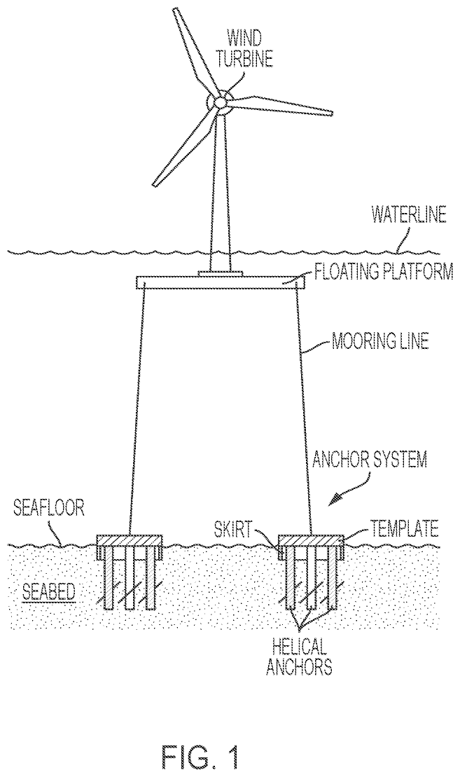

FIG. 1 depicts a schematic view of a single wind turbine moored to the seafloor using an anchoring system as described herein. As shown, a wind turbine is affixed to a floating platform at or near the waterline. Any suitable turbine and floating device may be used. Various turbine (single or multiple) and floating devices (e.g. floating platform, Dutch tri-floater, barge, spar, mono-hull TLP, etc.) may be used in conjunction with the anchoring system described herein.

The floating platform is affixed to one or more anchoring systems via one or more mooring lines.

Each anchoring system comprises a plurality of helical anchors, each of which is embedded in the seabed and coupled to the template. A skirt is provided at the periphery of the template such that the skirt is also embedded in the seabed to provide additional lateral support. The depth of the skirt, as with the helical anchors themselves, is determined on a case by case basis in light of the site where they are installed, factors such as depth, seabed composition, currents, and more may come into consideration. In some embodiments, the skirt extends into the seabed up to 5% of the length of the anchor shaft, in some embodiments the skirt extends 10%, 15%, 20%, 25%, 30%, 40%, or up to 50% of the length of the anchor shaft.

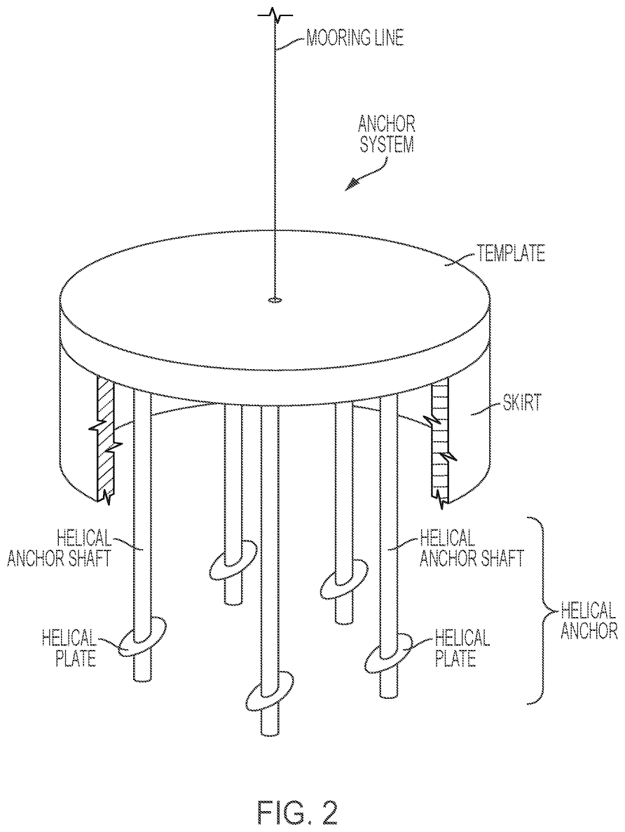

As depicted in FIG. 2, the template is circular and the accompanying skirt is a hollow cylinder. Any shape may be used, including oval, square, rectangle, etc. for the template, with sidewalls extending therefrom to form the skirt in a complimentary shape.

As depicted, a single mooring attachment and mooring line is affixed to the template. In some embodiments, multiple mooring lines may be affixed to the template.

The combination of the plurality of helical anchors, the template and the optional skirt create a secure anchoring arrangement that is easy to manufacture, ship, and install.

In some embodiments, two or more anchoring systems are used to moor the same platform.

These and other embodiments will be apparent to those of skill in the art upon reading this specification, without deviating from the scope and spirit of this disclosure.

The cost of anchoring offshore floating wind turbines is an obstacle to reducing the cost of energy from offshore floating wind projects and presents an opportunity for savings. Deep water at sites on the West Coast further drives up these costs. Traditional anchoring systems use large heavy weights, casings, or high drag embedment forces to achieve high-pullout forces required for moorings. High weights and forces ultimately convert into high costs. Proposed herein is a robust anchoring system that can be installed with low forces and managed remotely from a generic offshore vessel. This approach is being adopted as a cost-saving measure for seafloor characterization surveys in deepwater and can provide similar cost savings for mooring installation costs. This anchoring technology is scalable and applicable to many types of subsea foundations beyond offshore wind, such as oil & gas, pipelines, and other renewable energy systems. Beyond the public benefit of lower cost green energy, the system minimizes acoustic impacts on the environment.

What is claimed is:

1. An anchor system, comprising:
at least an anchor; and
a skirt surrounding the at least an anchor, wherein the skirt is configured to embed in a seabed and provide lateral support.

2. The anchor system of claim 1, wherein the skirt comprises a material comprising one or more of metal, stone or concrete.

3. The anchor system of claim 1, further comprising a template configured to act as a support for an installation tool, wherein the template is configured to act as a base for aligning and connecting the at least an anchor.

4. The anchor system of claim 3, wherein the skirt protrudes from a periphery of the template in a direction substantially parallel to a length of the at least an anchor thereby providing additional lateral support.

5. The anchor system of claim 3, wherein the skirt comprises an exterior shell attached to a circumference of the template.

6. The anchor system of claim 1, wherein the skirt extends between 10% to 50% of a length of an anchor shaft of the at least an anchor.

7. The anchor system of claim 1, wherein the skirt is configured to extend between 0% to 5% of a length of an anchor shaft into a seabed.

8. The anchor system of claim 1, further comprising at least a mooring line attached to the anchor system.

9. The anchor system of claim 8, further comprising at least a floating device attached the at least a mooring line.

10. The anchor system of claim 1, wherein template comprises a base portion comprising one or more of concrete and metal.

11. A method for installing an anchor system comprising:
embedding a plurality of anchors in a seabed; and
coupling, using an installation tool, the plurality of anchors to a template through which a shaft of each anchor passes, wherein the template acts as a base for aligning and connecting the plurality of anchors and as a support for the installation tool.

12. The method for installing the anchor system of claim 11, further comprising providing a skirt surrounding each anchor of the plurality of anchors.

13. The method for installing the anchor system of claim 12, wherein the skirt comprises a material comprising one or more of metal, stone or concrete.

14. The method for installing the anchor system of claim 12, wherein the skirt protrudes from a periphery of the template in a direction substantially parallel to a length of the plurality of anchors thereby providing additional lateral support.

15. The method for installing the anchor system of claim 12, wherein the skirt comprises a complimentary shape to the template.

16. The method for installing the anchor system of claim 11, wherein each anchor of the plurality of anchors is substantially parallel with each other.

17. The method for installing the anchor system of claim 11, wherein the installation tool comprises a subsea remote tool.

18. The method for installing the anchor system of claim 11, wherein the anchor system further comprises at least a mooring line attached the anchor system and at least a floating device attached to the at least a mooring line.

19. The method for installing the anchor system of claim 11, wherein at least an anchor of the plurality of anchors comprises a helical anchor.

20. An anchor system comprising:
at least an anchor;
a template through which a shaft of the at least an anchor passes, wherein the template acts as a base for aligning and connecting of the at least an anchor and as a support for an installation tool; and
a skirt surrounding the template, wherein the skirt is configured to embed in a seabed and provide lateral support.
